(19) United States
(12) Patent Application Publication
(10) Pub. No.: US 2009/0260744 A1
(43) Pub. Date: Oct. 22, 2009

(54) Device and Method for Building a Tyre

(75) Inventors: Herbert Bobinger, Augsburg (DE); Thomas Grimm, Augsburg (DE)

Correspondence Address: EPSTEIN DRANGEL BAZERMAN & JAMES, LLP, 60 EAST 42ND STREET, SUITE 820, NEW YORK, NY, 10165, US

(73) Assignee: TEXMAG GMBH VERTRIEBSGESELLSCHAFT, Thalwil (CH)

(21) Appl. No.: 12/226,295

(22) PCT Filed: Apr. 13, 2007
(86) PCT No.: PCT/EP2007/003298

§ 371 Date: Oct. 14, 2008

(30) Foreign Application Priority Data
Apr. 13, 2006 (DE) 10 2006 017 882.3

(51) Int. Cl. B29D 30/30; B29D 30/16

(52) U.S. Cl. 156/117; 156/351

(57) ABSTRACT

A tyre building machine (1) comprises a rotatable drum (2), to which strips of material (7) can be applied. Strips of material (7) are transported to the drum (2) by means of conveyors (3). The run of the pieces of material (7) transversely in relation to the running direction is sensed by means of a first sensor (9) and fed to a position controlling device (12). To compensate for machine- or transfer-induced errors, at least one second sensor (16), which senses the position of the strip of material (7) transversely in relation to the running direction, is provided in the region of the drum (2). An output signal of this second sensor (16) is in operative connection with the position controlling device (12) to correct the setpoint value correspondingly (FIG. 1).

The invention relates to a method for building a tyre according to the precharacterizing clause of Patent claim 1 and to a tyre building machine according to the precharacterizing clause of Patent claim 5.

EP 0 776 757 B1 discloses a tyre building machine which has a drum onto which various pieces of material are wound. The individual pieces of material are fed to the drum by means of conveying devices, which are formed by a multiplicity of rollers arranged one behind the other. These rollers are laterally movable, in order to realize lateral guidance of the pieces of material. This tyre building machine has proven very successful in practice and forms the starting point for the present invention.

The invention is based on the object of providing a tyre building machine and a method for its operation that are distinguished by improved quality of the tyres produced with it.

This object is achieved according to the invention by the measures of Patent claim 1 and by the features of Patent claim 5.

In the case of the method according to claim 1, strips of material are fed to a drum by conveyors and applied to it. In this way, identical and/or different strips of material can be arranged in layers one on top of the other to build the desired tyre. For example, the individual strips of material may consist of rubber, with different rubber mixtures being used if appropriate. Other strips of material generally comprise steel meshes, to give the finished tyre the necessary strength. In addition, strips of material may consist of textile fabrics, which likewise serve for strengthening the material and consequently giving the tyre a long service life. These individual strips of material are applied to the drum one after the other, so that they form layers radially one on top of the other. In this way, the desired tyre structure is obtained. To achieve a high production throughput, it is also possible to provide a number of drums, which are alternately charged with the strips of material. In principle, however, a single tyre building drum is adequate. The strips of material are fed to the drum by means of conveyors, which may be realized in various ways. For example, the conveyors may be realized by individual rollers or by conveyor belts. Transversely in relation to their running direction, the strips of material are led by the conveyor through a position control, so that they should run onto the drum in the correct position. The position control acts in this case in any desired direction that forms an acute or right angle with the running direction of the strip of material. It may bring about a lateral displacement or pivoting of the strip of material or a combination of these two movements. However, it has been found in practice that positional errors arise due to machine errors and inaccuracies in the transfer of the strips of material to the drum, so that the individual strips of material are no longer correctly aligned with one another. In the ideal case, the longitudinal centre line of all the strips of material should lie congruently one on top of the other. Any deviation from this ideal position leads to an impairment of the smooth running or the quality of the tyre created. In order to improve the positioning of the individual strips of material one on top of the other, the position of the strips of material on the drum is sensed transversely in relation to the running direction, that is to say substantially in the axial direction in relation to the drum, and compared with a setpoint value. The result of this comparison supplies a direct value of the alignment error between the strips of material on the one hand and the drum on the other hand. The result of this comparison is entered in the position control of the conveyors, so that in this way the measured error is taken into account in the next conveying cycle and is correspondingly reduced. The setpoint value of the position control is preferably corrected by the stated error or a fraction thereof. After just a few production cycles, this process leads to a positional accuracy of the strips of material lying one on top of the other that adequately compensates for all the machine and transfer errors. A tyre produced in this way accordingly has a very precise structure and is distinguished by very smooth running and at the same time high quality.

Since the signal for the position of the strip of material on the drum is only required when the conveyor performs its next cycle, the position of the strip of material, the result of the comparison or the output signal of the controller is stored. The stored signal in this case acts on the position control of the conveyor at the earliest when the next strip of material is fed in. In this way, at least positional errors of the drum are compensated. To compensate also for transfer errors and errors of the conveyor, it is only when the same conveyor performs its next conveying cycle that the stored signal acts on it. It has also been considered to keep the signal until the same working step becomes due for the next tyre. This involves storing at least one signal for each conveyor. Only signals that originate from strips of material that have been conveyed by the same conveyor act on the position control of the conveyor. In this way, the errors of each conveyor are individually corrected without influencing one another. If a number of drums are provided, at least one signal is preferably stored for each combination comprising a drum and a conveyor, in order to correct the effect of the drum.

According to claim 2, it is favourable if the result of the comparison is first fed to a controller, the output signal of which is entered in the position control of the conveyor. This allows the action of the position control to be optimally influenced. By choosing a suitable controller gain, each positional error of the strip of material on the drum can be compensated virtually completely. The setpoint value of the position control of the conveyor is adapted cycle by cycle by the control, in order to compensate optimally for existing errors.

According to claim 3, P, PI or PID action has proven successful as the control process. In the simplest case, purely proportional control is used, which generally already provides an adequately good control result. The proportionality factor of the P controller is preferably somewhat less than 1, to prevent oscillations of the control system. Proportionality values of approximately 0.3 to 0.8 have proven successful in practice. To achieve better correction of the existing machine error without causing oscillation problems, the addition of an integral component in the control action has proven successful, resulting in a PI controller. In particularly difficult control situations, a differential component may also be added, thereby resulting altogether in PID action.

Since the control process is dependent on the machine cycle, it is advantageous according to claim 4 if the controller is digitally realized, the cycle of the conveyor being used as the clock of the controller. In the case of a digital controller, the control action is realized in principle in a way comparable to that in the case of an analogue controller. However, time-dependent stages such as integrators and differentiators are realized by storing earlier values and using mathematical functions on the stored information. These mathematical operations normally run on the basis of a fixed clock. In the present case, however, it is more favourable to use the machine cycle of the conveyor as the clock. How long a specific conveyor needs to transport a strip of material is immaterial for the control. All that is important is that the correction information obtained is available when the same conveyor conveys the next piece of material to the drum. This is realized in the simplest way by using the machine cycle of the conveyor as the clock of the controller. If, for example, the controller is intended to realize integral action, it simply multiplies the input signal by a given constant and adds the product to the output value that has been determined for the last machine cycle of the same conveyor.

A tyre building machine according to claim 5 comprises a rotatable drum to which strips of material can be applied. The strips of material are in this case laid on the outer circumference of the drum, so that a desired layered structure is obtained to form the tyre. The individual strips of material preferably consist of rubber, steel meshes or woven fabrics. The strips of material are transported by means of conveyors, which are preferably realized by roller tracks or conveyor belts.

The conveyor is assigned at least one sensor, which senses the run of the pieces of material transversely in relation to the running direction. The sensor may sense a central marking of the pieces of material. Alternatively, it has also been considered to detect the bordering edge of the pieces of material. With a known width of the pieces of material, this definitively determines the run of the web. It has also been considered to provide at least two sensors, which sense both bordering edges of the strips of material. In this way it is possible to sense the centre of the strips of material independently of their width. The conveyors also have a position control for the strips of material by which the pieces of material are aligned transversely in relation to the web running direction. In the simplest case, the conveyor belt or the rollers is or are displaced transversely in relation to the running direction of the strips of material, in order to achieve the desired alignment of the strips of material. To compensate for positional errors of the drum and errors in the transfer of the strips of material onto the drum, at least one second sensor is provided in the region of the drum. This second sensor senses the position of the strip of material transversely in relation to the running direction and consequently makes it possible to determine the positional error of the strips of material on the drum. In order to reduce the positional fluctuations determined in this way of the strips of material on the drum in future production steps, the drum-side sensor is in operative connection with the position controlling device of the conveyors via storing means. This allows the positional errors of individual strips of material on the drum to be reduced step by step by a corresponding setpoint displacement of the conveyors. This tyre building machine is consequently capable of arranging individual strips of material very precisely one on top of the other and also reacts automatically to changing boundary conditions, which may influence the positioning of the individual strips of material on the drum.

The drum-side sensor senses the position of all the strips of material on the drum one after the other, independently of the conveyor by which they have been fed to the drum. In order to ensure that the measuring results achieved in this way are assigned to the position control of the conveyor respectively being used, the drum-side sensor is in operative connection with a multiplexer. This multiplexer respectively feeds the signals obtained to the specific storing means that is assigned to the specific conveyor that last conveyed its strip of material to the drum. If it is the turn of the same conveyor the next time, it can go back to the correction data that were determined for the last material conveyance.

According to claim 6, it is advantageous if the at least one first or second sensor senses a longitudinal bordering edge or a marking of the strip of material. In both cases, precise sensing of the position of the strip of material is obtained. The sensing of the bordering edge has the advantage that it can be carried out very simply, and in particular the strips of material do not have to be prepared in advance. It is possible to compensate for the accompanying disadvantage of width dependence of the measurement by using two sensors, which can consequently sense both bordering edges. If the strip of material is in any case provided with a scannable marking, this is preferably scanned by the sensor.

Since the correction information obtained is only required when the same conveyor performs its next cycle, according to claim 7 it is advantageous if the storing means are influenced by the conveying cycle of the conveyor, so that information is written to them and read out from them exactly in accordance with the cycle.

To achieve compensation for the machine-induced positional errors of the individual strips of material that is as precise as possible, according to claim 8 it is favourable if the drum-side sensor is in operative connection with at least one digital controller. A digital controller has the advantage over an analogue controller that long integration times can be realized unproblematically, and in particular without drift. Furthermore, the clock required in the case of digital controllers can be set as desired, so that the control can be set without any problem to different tyre building times by choosing a suitable clock. The clock is derived from the cycle of the tyre building machine itself, so that in this way the control parameters that are set are independent of the tyre building time. In particular, it is also immaterial whether individual tyre building steps take different amounts of time or whether the entire production process has to be interrupted for some reason or other. In these cases, the time unit with which the controller operates is extended, compressed or completely stopped, without having any effects on the controller parameters. The clock of the digital controller is derived from the cycle of the conveyor. Between two conveying cycles, the conveyor or its controller does not require any information, and in this time it also does not output any new information. A shorter clock would therefore be pointless. On the other hand, extending the length of the clock over a number of cycles of the conveyor would only extend the length of the control time of the controller, and this leads to poorer results.

Without restricting the scope of protection, the subject matter of the invention is explained by way of example on the basis of the drawing, in which:

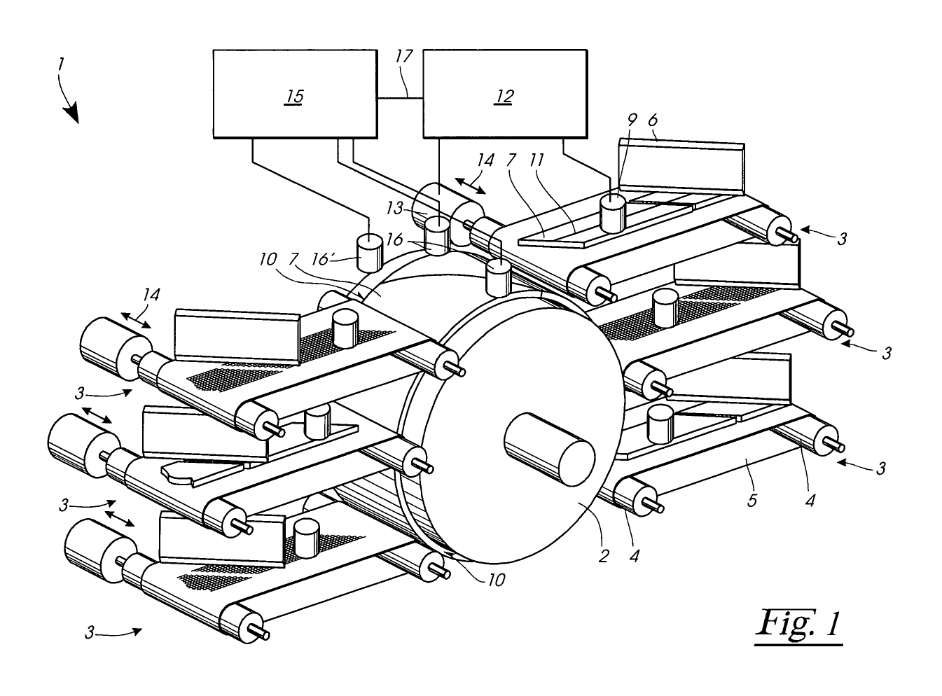

FIG. 1 shows a schematic, three-dimensional representation of a tyre building machine and

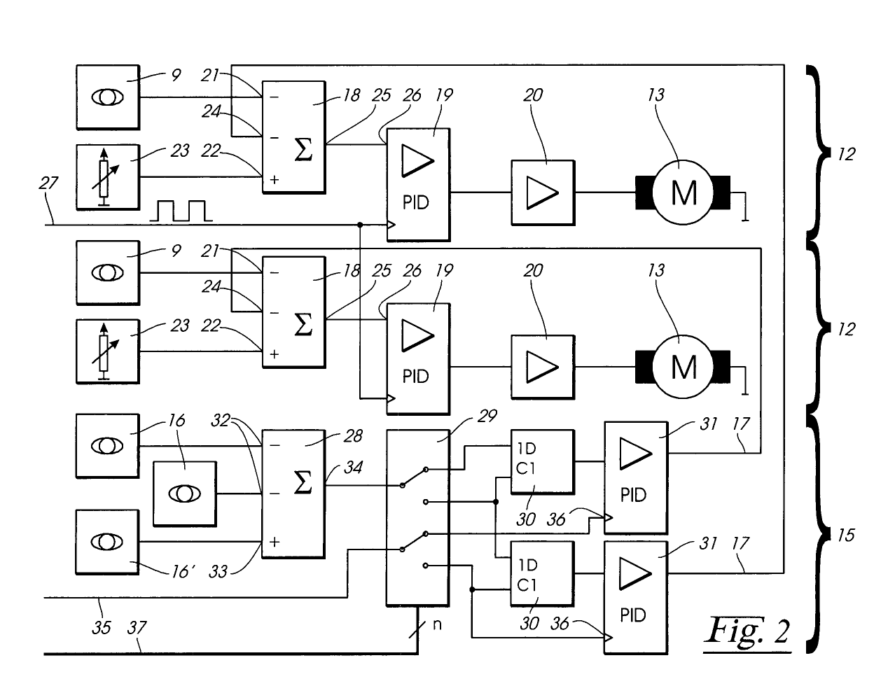

FIG. 2 shows a schematic, electronic circuit for the tyre building machine according to FIG. 1.

A tyre building drum 1 according to FIG. 1 has a drum 2, which is rotatably mounted. The drum 2 is assigned conveyors 3, which are substantially formed by two rotatably mounted deflecting rollers 4 and a conveyor belt 5. The deflecting rollers 4 are formed with a camber, so that they have a somewhat greater diameter in the middle than at the ends. This special shaping of the deflecting rollers 4 leads to favourable automatic run control of the conveyor belt 5, so that it centres itself on the deflecting rollers 4. This dispenses with the need for controlling measures to stabilize the running of the conveyor belt 5.

The conveyor 3 is also assigned a cutter 6, which obliquely cuts a strip of material 7 transported by the conveyor belt 5. The strip of material 7 is cut to length by the cutter 6 in such a way that the strip of material 7 fits exactly on the drum 2 or on the strips of material 7 already laid there. The oblique cut also has the effect of ensuring that the finished tyre does not have a weak point at the place of the cut.

The individual conveyors 3 transport the strips of material 7 to the drum 2, which rotates at least once about its axis 8 with each conveying cycle. In this way, the individual strips of material 7 are arranged in layers one on top of the other, so that altogether the desired layered structure of the tyre is obtained. In order that the strips of material 7 lie one on top of the other as exactly as possible on the drum 2, each conveyor 3 has at least one sensor 9, which senses a longitudinal bordering edge 10 of the strip of material 7. The sensor 9 preferably operates optically, and consequently contactlessly. Alternatively, the sensor 9 may also be formed such that it senses with ultrasonic waves or mechanically. The sensor 9 can also sense a printed-on marking 11 of the strip of material 7.

Each sensor 9 is in operative connection with its own position controlling device 12, which accepts the signal generated by the sensor 9 as an actual value. For the sake of overall clarity, only one position controlling device 12 has been represented. The position controlling device 12 acts on a motor 13, which displaces the deflecting rollers 4 in the direction of the arrow 14 in dependence on the output signal of the position controlling device 12. In this way, the strip of material 7 is positioned.

In order also to correct errors with respect to the positioning of the drum 2 and errors in the transfer of the strips of material 7 from the conveyor 3 to the drum 2, a further control device 15 is provided. This is influenced by two further sensors 16 that are assigned to the drum 2. The sensors 16 may be realized in the same way as the sensor 9. The sensors 16 sense both bordering edges 10 of the strip of material 7. In this way, sensing of the centre line of the strip of material 7 can be realized independently of the width of the strip of material 7. Alternatively, it is possible to use only one sensor 16, which senses only one of the longitudinal bordering edges 10 of the strip of material 7.

The drum 2 is also assigned a further sensor 16′, which senses a bordering edge of the drum 2. This sensor 16′ supplies a reference signal, which allows the signals of the sensors 16 to be converted into relative values with respect to the drum 2. This allows the correction of positional errors of the strips of material 7 that originate from incorrect positioning of the drum 2.

The sensor 16 determines the relative position of the strip of material 7 on the drum 2, so that all the machine and transfer errors are taken into account. This error influences the control device 15, which uses it to calculate an output signal. The output signal of the control device 15 is in operative connection with the position controlling device 12 of the conveyor 3 via a line 17. It thereby changes the setpoint value of the position controlling device 12, so that the setpoint value of the position controlling device 12 is changed in dependence on the measured error for the next tyre to be built. The change is in this case performed by providing that, at least after a number of tyres have been built, the strip of material 7 is fed to the drum 2 in such an offset manner that the machine- and transfer-induced error is corrected in this way.

FIG. 2 shows a schematic circuit for the tyre building machine 1 according to FIG. 1. The circuit of the position controlling device 12 of one of the conveyors 3 is represented in the top row. The position controlling device 12 substantially comprises an adder 18, a control amplifier 19 and a power amplifier 20. The adder 18 has an inverting input 21, which is connected to the sensor 9. The sensor 9 thereby supplies the actual value for the position controlling device 12. A non-inverting input 22 of the adder 18 is connected to a setpoint generator 23, which prescribes the setpoint value for the position of the strip of material 7. The setpoint generator 23 can generally be set. In particular, it has been considered to form the setpoint generator 23 as an arithmetic and logic unit, which determines the correct, desired edge position of the strip of material 7 from the width of the latter. Finally, the adder 18 has a further inverting input 24, the function of which is explained later.

An output 25 of the adder 18 is in operative connection with an input 26 of the control amplifier 19. The control amplifier 19 has PID action and consequently has a proportional component, an integral component and a differential component. The gain factors of the individual components may be set as desired. The control amplifier 19 is realized in the form of a digital amplifier, a clock line 27 forming the time signal of the control amplifier 19. This time signal is periodic, it being possible for the frequency to be adapted to the actual requirements.

The control amplifier 19 is in operative connection on the output side with the power amplifier 20, which amplifies the calculated control signal to an adequate power to allow it to be used to activate the motor 13 of the conveyor 3.

A further position controlling device 12 of a further conveyor 3 is represented in the second row. The structure of the second position controlling device 12 is identical to the first-mentioned, so no detailed description of this further position controlling device is given. In practical use, each conveyor 3 is provided with a position controlling device 12 of its own. For the sake of better overall clarity, however, only two of the position controlling devices 12 are represented in FIG. 2.

The control device 15 is represented in the third row. This comprises an adder 28, a multiplexer 29, storing means 30 and control amplifiers 31.

The adder 28 has two inverting inputs 32, which are connected to the drum-side sensors 16. In this way, the aggregate signal of the two drum-side sensors is calculated, this signal being proportional to the mean value and consequently representing the position of the centre line of the strip of material 7. The adder 28 also has a non-inverting input 33, which is connected to the sensor 16′, which senses the end edge of the drum 2. Since the signals of the sensors 16 on the one hand and 16′ on the other hand are subtracted from one another by the adder 28, the adder 28 supplies at its output 34 a signal that is proportional to the position of the centre line of the strip of material 7 in relation to the drum 2. This signal therefore reproduces the exact positioning error of the strip of material 7.

An output 34 of the adder 28 is in operative connection with the multiplexer 29, which feeds this signal to the storing means 30 in dependence on an address 35. The address 35 in this case specifies the conveyor 3 that is active at the time. The storing means 30 accordingly stores the current offset of the strip of material 7 in relation to the drum 2 separately for each conveyor 3.

The storing means 30 are respectively connected to the control amplifier 31, which may be formed in the same way as the control amplifier 19. The main difference from the control amplifier 19, however, is the fact that the control amplifiers 31 do not receive a genuine time signal as a clock signal. Instead, clock inputs 36 and control amplifiers 31 are connected to the multiplexer 29, which together with the output signal of the adder 28 also switches over a machine clock signal 37. This machine clock signal 37 supplies an active clock-pulse edge for each operating cycle of the conveyor 3. In this way, the time-dependent I and D components of the control amplifier 19 are in fact calculated in dependence on the operating cycles of the conveyor 3.

The control amplifiers 31 are in operative connection on the output side with the inputs 24 of the adders 18 via the lines 17. This allows the control amplifiers 31 to act on the position controlling devices 12 in such a way that the measured offset of the strips of material 7 on the drum 2 is gradually corrected from tyre to tyre. Consequently, a very precise alignment of the strips of material 7 in relation to the drum 2 is obtained after a relatively small number of tyres have been produced. In simple applications, it is also possible to dispense with the control amplifier 31. The storing means 30 then act directly on the adders 18.

### LIST OF REFERENCE NUMERALS

1 tyre building machine
2 drum
3 conveyor
4 deflecting roller
5 conveyor belt
6 cutter
7 strip of material
8 axis
9 first sensor
10 longitudinal bordering edge
11 marking
12 position controlling device
13 motor
14 correction device
15 control device
16 second sensor
16′ third sensor
17 line
18 adder
19 control amplifier
20 power amplifier
21 inverting input
22 non-inverting input
23 setpoint generator
24 inverting input
25 output
26 input
27 clock line
28 adder
29 multiplexer
30 storing means
31 control amplifier
32 inverting input
33 non-inverting input
34 output
35 address
36 clock input
37 machine clock signal

1. Method for building a tyre, in which strips of material (7) are fed by conveyors (3) to at least one drum (2) and led through a position control transversely in relation to their running direction, to be subsequently applied to the drum (2), the position of the strips of material (7) on the drum (2) transversely in relation to the running direction being sensed and compared with a setpoint value, and the result of the comparison being entered in the position control of at least one of the conveyors (3), characterized in that the position of the strip of material (7), the result of the comparison and/or the output signal of the controller (15) is stored, with the stored signal acting on the position control of the conveyor (3) at the earliest when the next strip of material (7) is fed in by the same conveyor.

2. Method according to claim 1, characterized in that the result of the comparison is fed to a controller (15), the output signal of which is entered in the position control.

3. Method according to claim 2, characterized in that the controller (15) has P, PI or PID action.

4. Method according to claim 3, characterized in that the controller (15) is digitally realized, the cycle of the conveyor (3) being used as the clock of the controller (15).

5. Tyre building machine comprising a rotatable drum (2), to which strips of material (7) that can be transported to the drum (2) by means of conveyors (3) can be applied, the run of the strips of material (7) transversely in relation to the running direction being sensed by at least one first sensor (9), which is in operative connection with a position controlling device, with at least one second sensor (16), which is in operative connection with the position controlling device (12) and senses the position of the strip of material (7) transversely in relation to the running direction, being provided in the region of the drum (2), characterized in that the at least one second sensor (16) is in operative connection with first storing means (30), which are in operative connection on the output side with at least one multiplexer (29), which feeds the stored signals to storing means (30) that are assigned to the conveyors (3) and the stored signals of which act on the position control of the conveyor (3) at the earliest when the next strip of material (7) is fed in by the same conveyor.

6. Tyre building machine according to claim 5, characterized in that the at least one first sensor (9) and/or second sensor (16) sense(s) a longitudinal bordering edge (10) and/or marking (11) of the strip of material (7).

7. Tyre building machine according to claim 5 or 6, characterized in that the storing means (30) are influenced by the conveying cycle (37) of the conveyor (3).

8. Tyre building machine according to at least one of claims 5 to 7, characterized in that the at least one second sensor (16) is in operative connection with at least one digital controller (31), the clock of which is derived from the cycle (37) of the conveyor (3).
